(19) United States
(12) Patent Application Publication
(10) Pub. No.: US 2026/0222183 A1
(43) Pub. Date: Jul. 30, 2026

(54) Enhanced Data Privacy in Edge Devices via Secure Multiparty Computation on FIDO Onboarded Devices

(71) Applicant: Dell Products L.P., Round Rock, TX (US)

(72) Inventors: Jia Yuan Chia, Singapore (SG); Kah Wai Au, Singapore (SG)

(73) Assignee: Dell Products L.P., Round Rock, TX (US)

(21) Appl. No.: 19/040,276

(22) Filed: Jan. 29, 2025

(51) Int. Cl. H04L 9/08; H04L 67/10

(52) U.S. Cl. CPC H04L 9/085; H04L 67/10; H04L 2209/46

(57) ABSTRACT

A system for enhancing data privacy in edge devices through Secure Multiparty Computation (SMPC) integrated with Fast IDentity Online (FIDO) onboarding. The system securely onboards Edge Compute Endpoints (ECEs) to an Edge Orchestrator (EO) using FIDO, establishes secure communication channels, and deploys data and sharing agents to each ECE. Data collected at each ECE is split into shares and distributed among other ECEs for computation, thereby ensuring data privacy. Each ECE sends a computed data share to the EO for aggregation into a computed dataset.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination.

IHSs can be used in a distributed environment as edge devices. Example edge devices include applications running in a retail store, such as point of sale device, a gateway, a compute or storage device not operating in a datacenter, remote industrial sensor and monitoring equipment, or deployed telecommunications equipment. Edge devices may be vulnerable to attack due to being in a remote location and/or a lack of physical security. Edge devices often service critical data. The edge devices may run autonomously without network connectivity to a central control plane for an extended period of time. In these architectures, it is important to protect the data stored on remote edge devices from compromise.

### SUMMARY

The embodiments involve securely onboarding Edge Compute Endpoints (ECEs) to an Edge Orchestrator (EO) using Fast IDentity Online (FIDO) and establishing trusted communication channels. The EO then deploys data and sharing agents to each ECE through these secure channels. The data agents collect data at each ECE. The data on each ECE is then split into shares using a sharing protocol such as Shamir's Secret Sharing and securely distributed among the ECEs. Each ECE performs computations on its data shares and sends the results back to the EO, which aggregates them into a final computed data output. This approach integrates FIDO's secure onboarding with Secure Multi-Party Computation (SMPC) to ensure data privacy at the edge device where the data is collected. By distributing trust across the network, the solution prevents any single device from compromising data privacy, creating a secure, end-to-end system for managing sensitive data directly at the edge.

In one embodiment, a system comprising an edge orchestrator is configured to manage operation of a plurality of edge devices in communication with the edge orchestrator, each of the edge devices comprising a processor and a memory coupled to the processor, the memory having program instructions stored thereon that, upon execution, cause the processor to collect data from an edge device location using a data agent; share portions of the collected data, by a sharing agent, with other edge devices using a secure multi-party computation protocol; aggregate a portion of the collected data with one or more shared portions of data collected by other edge devices; and send aggregated data to the edge orchestrator. The edge orchestrator further comprises a processor and a memory coupled to the processor, the memory having program instructions stored thereon that, upon execution, cause the processor to aggregate multiple portions of aggregated data into computed data, wherein the portions of aggregated data are each received from a different edge device.

In a further embodiment, the system further comprises a secure channel established between each edge device and the edge orchestrator, wherein the secure channel uses a Mutual Transport Layer Security (mTLS) protocol.

In yet another embodiment, the system further comprises a secure cluster channel established between each edge device and the other edge devices, wherein the edge device sharing agents share the portions of the collected data with the other edge devices using the secure cluster channel.

In an additional embodiment, a method for secure exchange of information, comprises deploying agents from an edge orchestrator to a cluster of edge devices; instructing data agents to collect a defined set of data at each edge device; dividing the collected data into a plurality of shares by a sharing agents; transferring shares of the collected data among the edge devices so that a data set collected at each edge device is divided among all of the edge devices; computing, at each edge device, upon the shares of the collected data to create a computed data share; transferring the computed data shares from each edge device to the edge orchestrator; and aggregating, by the edge orchestrator, all of the computed data shares into a computed data set. The data agents on each edge device collect the defined set of data at an edge device location.

In a further embodiment, the method includes transferring the collected data from the data agent to the sharing agent, wherein the sharing agent on each edge device creates a plurality of shares of the collected data.

In yet another embodiment, the further includes distributing the shares of collected data from each edge device to other edge devices so that each edge device has approximately the same size portion of the data share, wherein the shares of collected data are distributed among the edge devices using a secure channel for the edge device cluster, and wherein the shares of collected data are distributed using a secure multi-party computation protocol, such as a Shamir's secret sharing algorithm.

In an additional embodiment, the method includes providing data collection instructions to the data handling agents using a deployment service on the edge orchestrator, and aggregating the computed data shares into a computed data set using an aggregation engine on the edge orchestrator.

In a further embodiment, a system comprises a plurality of edge devices forming an edge cluster; an edge orchestrator having a deployment service and an aggregation engine, the deployment service configured to send a data agent and a sharing agent to each of the edge devices; a secure orchestrator channel established between each edge device and the edge orchestrator; and a secure mesh channel established among the devices in the edge cluster; wherein the data agent on each edge device is configured to collect data from a respective location, and wherein the sharing agent is configured to distribute portions of the collected data among all of the devices in the edge cluster.

In another embodiment, the disclosure includes a system wherein the sharing agent, on each edge device, is further configured to compute a computed data share from distributed portions of edge device data and to transfer the computed data share to the aggregation engine; and the aggregation engine is configured to aggregate computed data shares from each edge device into a computed data set.

### BRIEF DESCRIPTION OF THE DRAWINGS

Having thus described the invention in general terms, reference will now be made to the accompanying drawings, which are not necessarily drawn to scale, and wherein:

FIG. 1 illustrates FIDO onboarding of Edge Compute Endpoints (ECE) to an Edge Orchestrator (EO).

FIGS. 2A-2C illustrate a process for establishing secure communications among multiple ECEs via Mutual Transport Layer Security (mTLS).

FIGS. 3A-3D illustrate a process for Secure Multi-Party Computation (SMPC) using edge devices.

FIG. 4 shows an example of an Information Handling System (IHS) configured to implement systems and methods as described herein for enhanced data privacy in edge devices using Secure Multiparty Computation for FIDO onboarded devices.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The Fast IDentity Online (FIDO) Alliance has promulgated a set of security-focused technologies and protocols intended to simplify and enhance cybersecurity. Information handling systems, such as server devices and/or other computing devices, may benefit by performing authentication via the FIDO Device Onboarding (FDO) protocol, particularly when provided at the “edge” of a network (“edge devices”). There is a significant need for computations that involve sensitive data from multiple parties, which requires both privacy preservation and computation integrity, such as computations involving financial or medical data. Traditional cloud-based solutions pose privacy risks and latency issues, while edge devices often lack robust security mechanisms. There are various mechanisms that can help secure an edge device in the field, such as FIDO Device Onboarding, but these solutions can only guarantee device security but not data privacy. With FIDO Device Onboarding, the devices must be onboarded to a device owner but in some use cases that does not mean the data collected by the device belongs to the owner as well.

The embodiments disclosed herein provide a solution to implement Secure Multi-Party Computation (SMPC) into FIDO onboarded edge devices, which provides device and data security as well as guaranteed data privacy in the process.

In an example use of FIDO protocols, a computing device manufacturer may manufacture an edge device using the FDO Device Initialization (DI) (FDO-DI) protocol, which provides for the generation of a public/private key pair, secure storage of the private key in the edge computing device, and inclusion of the public key in a digital ownership voucher that defines an “owner” of the edge device. The digital ownership voucher is configured to be transferred to using public/private key signing techniques to different “owners” of the edge device as it moves through the supply chain (e.g., among various resellers known the art) to an end user that becomes the “last owner” of the edge device.

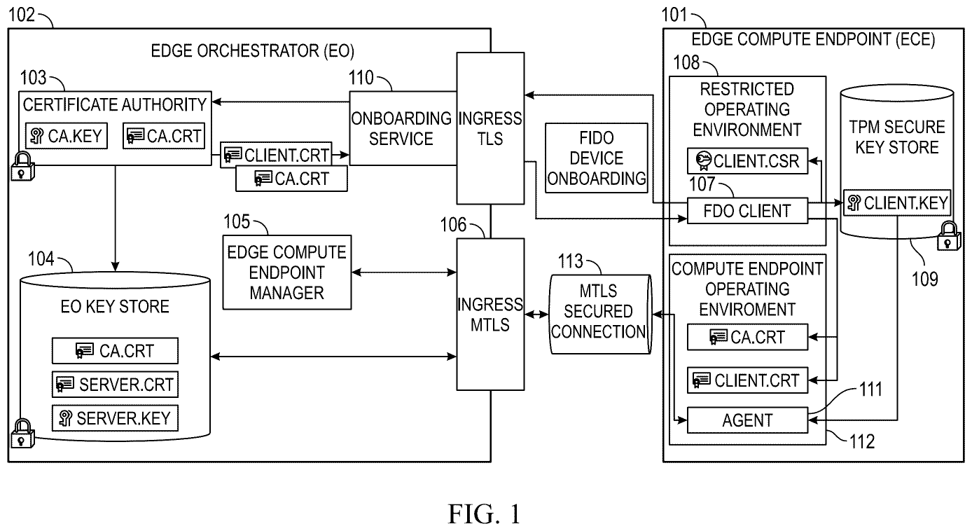

FIG. 1 illustrates FIDO onboarding of Edge Compute Endpoints (ECE) 101 to an Edge Orchestrator (EO) 102. At the end of the secure onboarding, a secure channel is used to setup Mutual Transport Layer Security (mTLS) to secure the ECE 101 to EO 102 communications.

Certificate Authority (CA) 103 on EO 102 generates a CA certificate (ca.crt) and CA key (ca.key). A server certificate (server.crt) and server key (server.key) are also generated and are saved in an EO key store 104 along with the CA certificate.

An edge compute endpoint manager manages an ingress controller or load balancer 106 where incoming TLS connections are terminated. The ingress controller 106 is configured to use the CA certificate, the server private key, and the server certificate from the EO key store 104.

On the ECE 101, a FDO client 107 generates a client private key (client.key) within a restricted operating environment 108, such as a Trusted Platform Module (TPM). The client key is stored in a TPM secure key store 109. The FDO client 107 also generates a client certificate signing request (CSR) (client.csr). FDO client 107 sends the client CSR to the EO certificate authority 103.

Working with an onboarding service 110, the EO certificate authority 103 generates a client certificate (client.crt) using the client CSR along with the CA certificate and the CA key. The EO certificate authority 103 sends the client certificate along with its CA certificate back to ECE 101.

The FDO client 107 provides the CA certificate and client certificate to an agent 111 running in compute endpoint operating environment 112. The agent 111 uses TPM, the CA certificate, and the client certificate to establish an mTLS secure channel 113 between ECE 101 and EO 102. The TPM internally uses the securely stored client private key for encryption/signing. Therefore, the client private key never leaves the TPM module.

The implementation illustrated in FIG. 1 is fully secure and zero touch, which means that the user installing ECE 101 just needs to plug into the network and ECE 101 will be onboard.

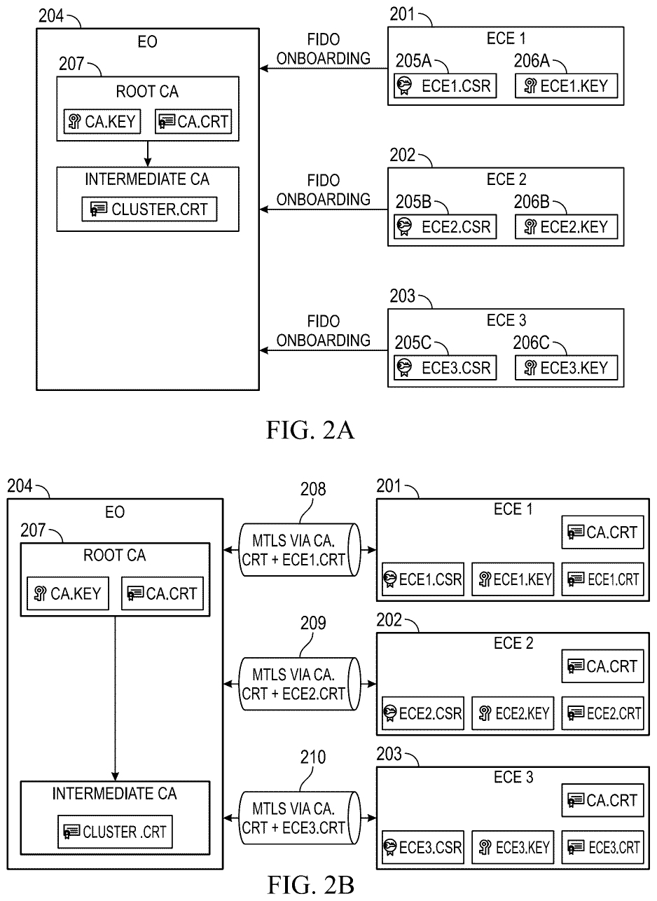

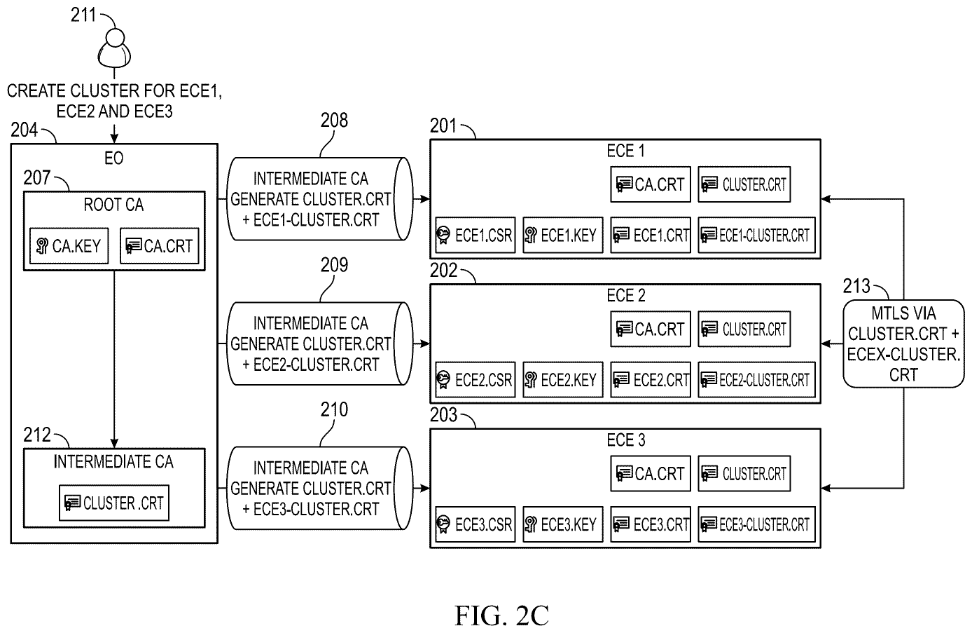

FIGS. 2A-2C illustrate a process for establishing secure communications among multiple ECEs via mTLS. Firstly, as shown in FIG. 2A, ECEs 201-203 are onboarded to EO 204 via FIDO Device Onboarding as discussed in reference to FIG. 1. Each ECE 201-203 has an ECE certificate signing request (ece.csr) 205 and an ECE private key (ece.key) 206. A root certificate authority 207 on EO 204 generates a CA key (ca.key) and CA certificate (ca.crt).

As shown in FIG. 2B, during the FDO process, all the ECEs 201-203 setup mTLS connections 208-210 with EO 204 as discussed in reference to FIG. 1.

As shown in FIG. 2C, a user 211, such as a network administrator, creates a cluster between all of the ECEs 201-203 via EO 204. During the cluster creation process, all ECEs 201-203 will send their certificate signing request (client.csr) to EO 204 again via the established mTLS channels 208-210. An intermediate cluster authority 212 in EO 204 generates a cluster certificate (cluster.crt). The EO 204 uses the ECE certificate signing requests (client.csr) and the cluster certificate to generate an ECE-cluster certificate (ece-cluster.crt) for each ECE 201-203. The EO 204 returns the respective certificates to each ECE 201-203 along with the cluster certificate. With the cluster certificate and the respective ECE-cluster certificate, the ECEs 201-203 establish direct mTLS communication 213 with each other.

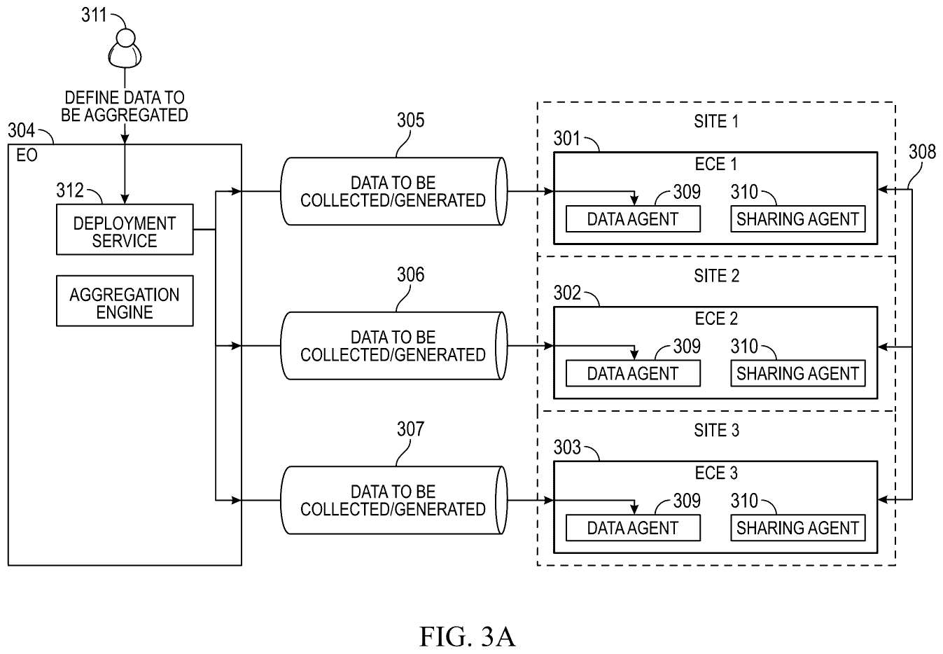

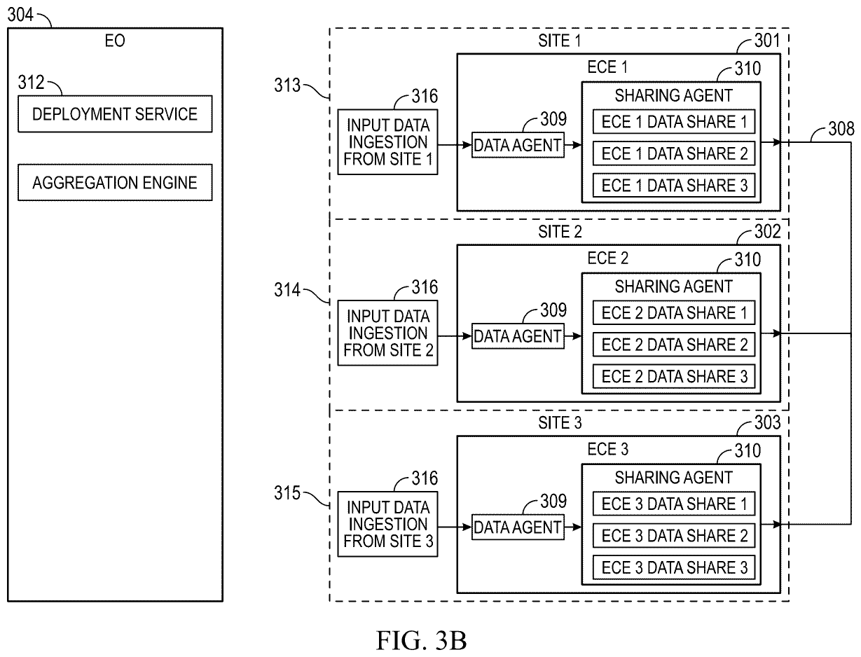

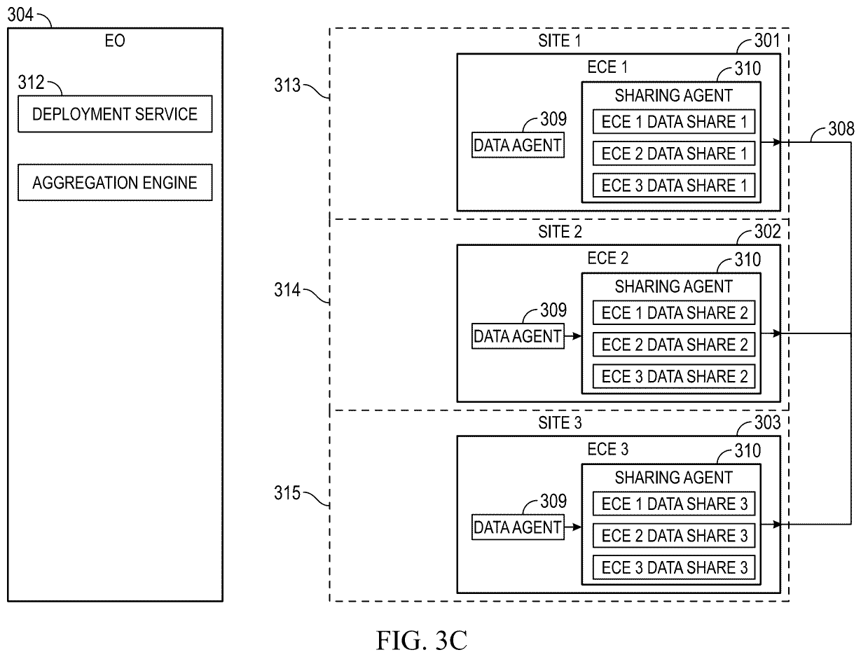

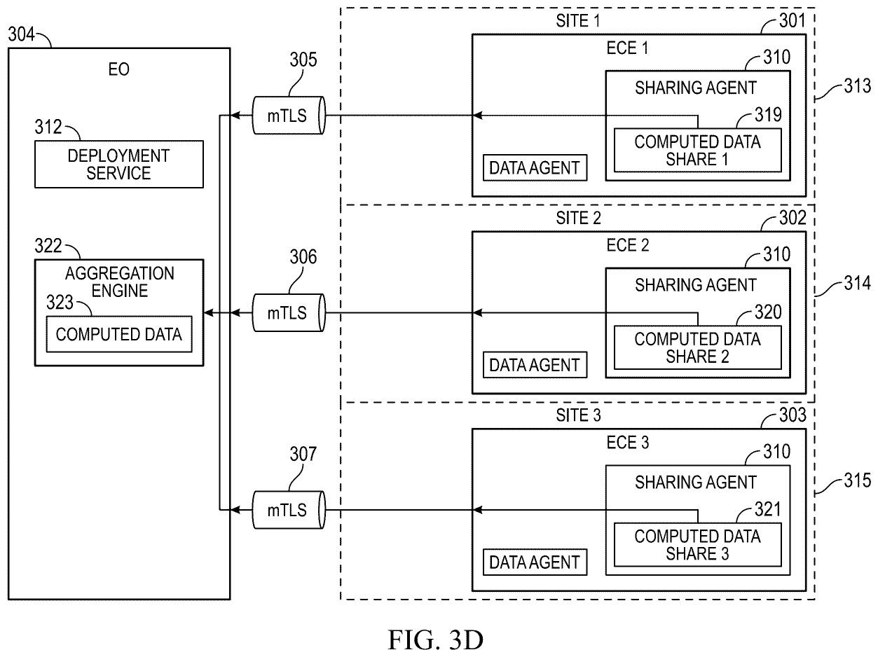

FIGS. 3A-3D illustrate a process for secure multi-party computation (SMPC) using edge devices. A number of ECE devices 301-303 are securely onboarded to EO 304 via FIDO device onboarding. During the onboarding process, each ECE device 301-303 establishes a secure and trusted communication channel 305-307, such as a mTLS connection, to EO 304. Additionally, each ECE device 301-303 is able to communicate securely with the other ECEs in a secure mesh 308. The ECE devices 301-303 can leverage this setup to deploy a secure multi-party computation system.

Referring to FIG. 3A, the EO 304 deploys software components into all the ECEs 301-303 via secure channels 305-307. The software components include a data agent 309 and a sharing agent 310. A user 311 uses a deployment service 312 in the EO 304 to define the data that is to be collected and/or generated by the ECE devices 301-303. The deployment service 312 in EO 304 then deploys the data collection instructions to data agents 309 within all ECEs 301-303 via secure channels 305-307. The data collection instructions are stored in the data agents 309. The data collection instructions are then executed by the respective data agents 309, which start collecting or generating data in their respective locations.

As illustrated in FIG. 3B, each ECE device 301-303 may be located at a different locations or sites 313-315. For example, each site 313-315 may be a separate medical facility or financial center that has patient or customer data that needs to be stored securely and shared only under high levels of data protection. Each data agent 309 ingests local data 316-318 from its respective site 313-315. After the local data has been collected or generated, the data agent 309 will transfer the data to the sharing agent 310 installed within the local ECE device 301-303.

The ECE devices can use any SMPC protocol to share the data. In one configuration, be Shamir's Secret Sharing (SSS) protocol may be used to split data into multiple shares and then transfer different shares of data to other ECEs within the cluster via their secure channel 308. The data shares will be split in a way that most, if not all, shares must be present and aggregated to recover the original data. The SSS protocol uses an algorithm that breaks up a secret into multiple shares then distributes these shares among peers (e.g., ECEs 301-303). The secret cannot be retrieved unless a configurable quorum of peers (e.g., ECEs 301-303) agrees to share their individual piece of the secret. This allows for distributing sensitive material, such as medical or financial information, among several ECE devices 301-303. The data sharing among participating ECEs 301-303 must be within the secure mesh 308 cannot be shared via EO 304 because the EO would be able reconstruct the data if all of the shares passed thru it.

In FIG. 3B, each ECE 301-303 divides its respective data into three shares to match the number of ECEs within the peer group. The three individual shares in each ECE are provided to the respective sharing agents 310, which then transfer the shares to other ECEs via secure mesh 308.

As shown in FIG. 3C, after the data sharing by sharing agents 310, each ECE 301-303 will take in the same portion of data shares from all ECEs. For example, ECE 301 has its own data share (ECE1 Data Share 1) as well as data shares from ECE 302 (ECE2 Data Share 1) and 303 (ECE3 Data Share 1). Similarly, ECE 302 has its own data share (ECE2 Data Share 2) as well as data shares from ECE 301 (ECE1 Data Share 2) and 303 (ECE3 Data Share 2); and ECE 303 has its own data share (ECE3 Data Share 3) as well as data shares from ECE 301 (ECE1 Data Share 3) and 302 (ECE3 Data Share 3). The individual data shares cannot be used to get raw data from the originating location.

Once each sharing agent 310 has data shares from each of the ECEs in its peer group, then the sharing agents 310 begin computing upon the data. As shown in FIG. 3D, each sharing agent 310 creates a computed data share 319-321 based upon the individual data shares it received. For example, in ECE 301, the Computed Data Share 1 has been computed from ECE1 Data Share 1, ECE2 Data Share 1, and ECE3 Data Share 1.

After computed data share 319-321 is generated, each ECE 301-303 will then transfer the computed data share to an aggregation engine 322 in EO 304. The computed data shares 319-321 are transferred to EO 304 via the secure mTLS channels 305-307 for each ECE 301-303. Upon receiving all the computed data shares, the aggregation engine 322 is used to aggregate the data and to produce a final aggregated output of computed data 323 that can be used for subsequent operations.

In the illustrated example, three sets of aggregated data (i.e., computed data shares 319-321) are sent to the EO and then the EO creates another aggregated data set (i.e., computed data 323) using the shares received from the ECEs. Because the data has already been aggregated once by the ECE network, the EO does not know and cannot determine the source location of any specific data within the aggregated data shares 319-321. By further combining the data shares to create the computed data set 323, users outside EO 304 cannot determine the source location or source ECE of specific data.

In an example use case, ECEs 301-303 may be used to collect medical data that needs to be stored securely and not shared in a way that specific data can be associated with an individual patient. The system for sharing data disclosed herein may be used, for example, to calculate statistics, such as among different age groups, and to send that statistics data to the EO for use by a government agency to track demographic data. The computed data shares sent to the EO cannot be used to get back to the raw data from a particular facility or patient.

Although three edge devices are shown in the examples above, it will be understood that any number of edge devices may be used in other configurations. Additionally, in the example solution above, Shamir's Secret Sharing is used for an SMPC protocol. It will be understood that alternative SMPC techniques, such as Additive Secret Sharing or the Garbled Circuit protocol, can also be applied to leverage the secure channel 308 that is setup between the ECEs. This configuration uses FIDO security features for secure onboarding, where each edge device's identity is verified before joining the network and the cluster. This minimizes the risk of any party or edge device being a malicious or dishonest actor within the SMPC protocol. Using the secure mTLS channel, the EO can also continuously push security updates as well as perform security monitoring to the onboarded ECEs.

As used herein, FIDO Device Onboarding (FDO) refers to an automatic onboarding protocol for IoT devices. FDO permits late binding of device credentials, so that one manufactured device may be onboard, without modification, to many different IOT platforms.

The term Edge Orchestrator (EO) refers to an endpoint management and orchestration software that provides a centralized platform for controlling compute endpoints and workloads on these endpoints. This software also acts as the device owner in FIDO Device Onboarding.

The term Edge Compute Endpoint (ECE) refers to the servers, gateways, or client devices that is managed centrally by Edge Orchestrator. These devices are onboarded to Edge Orchestrator with FIDO device onboarding.

The term Mutual Transport Layer Security (mTLS) refers to a method for mutual authentication where it ensures that the parties at each end of the network connection are who they claim to be by verifying that they both have the correct private key.

A Cluster Certificate Authority (Cluster CA) as used herein refers to the intermediate CA used in EO to secure the ECE to ECE communication.

The term Trusted Platform Module (TPM) refers to a computer chip (microcontroller) on the ECE that can securely store artifacts used to authenticate the platform, in our case the private keys used for client authentication in mTLS connections.

The term Secure Multi-Party Computation (SMPC) refers to a cryptographic protocol and distributes computation across multiple parties where no individual party can view other parties'data.

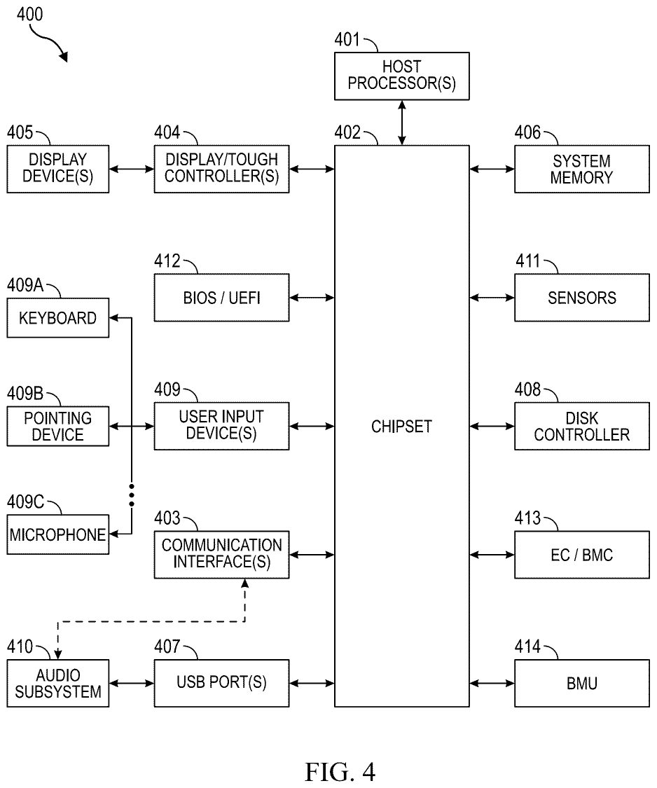

FIG. 4 shows an example of an Information Handling System (IHS) 400 configured to implement systems and methods as described herein for enhanced data privacy in edge devices using Secure Multiparty Computation for FIDO onboarded devices. IHS 400 may be used as an edge device 101, 201-203, or 301-303 or as an edge orchestrator 102, 204, or 304.

As depicted, IHS 400 includes host processor(s) 401. In various embodiments, IHS 400 may be a single-processor system, or a multi-processor system including two or more processors. Host processor(s) 401 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 400 includes chipset 402 coupled to host processor(s) 401. Chipset 402 may provide host processor(s) 401 with access to resources. In some cases, chipset 402 may utilize a QuickPath Interconnect (QPI) bus to communicate with host processor(s) 401. Chipset 402 may also be coupled to communication interface(s) 403 to enable communications between IHS 400 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 403 may be used to communicate with peripheral devices (e.g., Bluetooth speakers, microphones, headsets, etc.). Moreover, communication interface(s) 403 may be coupled to chipset 402 via a Peripheral Component Interconnect Express (PCIe) bus, or the like.

Chipset 402 may be coupled to display and/or touchscreen controller(s) 404, which may include one or more Graphics Processor Units (GPUs) on a graphics bus, such as an Accelerated Graphics Port (AGP) or PCIe bus. As shown, display controller(s) 404 provide video or display signals to one or more display device(s) 405. Display device(s) 405 may include Liquid Crystal Display (LCD), Light Emitting Diode (LED), Organic LED (OLED), or other thin film display technologies. Display device(s) 405 may include a plurality of pixels arranged in a matrix, configured to display visual information, such as text, two-dimensional images, video, three-dimensional images, etc. In some cases, display device(s) 405 may be provided as a single continuous display, rather than two discrete displays.

Chipset 402 may provide host processor(s) 401 and/or display controller(s) 404 with access to system memory 406. In various embodiments, system memory 406 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 402 may also provide host processor(s) 401 with access to one or more Universal Serial Bus (USB) ports/controllers 407, to which one or more peripheral devices may be coupled (e.g., integrated or external webcams, microphones, speakers, etc.).

Chipset 402 may further provide host processor(s) 401 with access to a disk controller 408, which may include a disk interface that connects the disc controller 408 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 400. An example of external interface includes a USB interface, an IEEE 1394 (Firewire) interface, a proprietary interface, or a combination thereof.

Chipset 402 may also provide access to one or more user input devices 409, for example, using a super I/O controller or the like. Examples of user input devices 409 include, but are not limited to, a keyboard 409a, pointing device 409b, such as a mouse, trackball, stylus, or active pen, and/or microphone(s) 409c. Other user input devices 409 (not shown) may include a camera, touchpad, totem, etc. Each user input device 409 may include a respective controller (e.g., a touchpad may have its own touchpad controller) that interfaces with chipset 402 through a wired or wireless connection, for example via communication interfaces(s) 403 and/or USB port(s) 407. Other input devices, such as keyboard 409a, may use a keyboard controller in an operating system.

In some cases, chipset 402 may also provide access to one or more output devices, such as an audio subsystem 410, speakers, headsets, video projectors, paper printers, 3D printers, Virtual/Augmented Reality (VR/AR) devices, etc. The output devices may be accessed, for example, via communication interfaces(s) 403 and/or USB port(s) 407. Audio subsystem 410 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 402 may further provide an interface for communications with one or more hardware sensors 411. Sensors 411 may be disposed on or within the chassis of IHS 400, or otherwise coupled to IHS 400, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 412 is coupled to chipset 402. UEFI was designed as a successor to BIOS, and many modern IHSs utilize UEFI in addition to or instead of a BIOS. Accordingly, BIOS/UEFI 412 is intended to also encompass a UEFI component. BIOS/UEFI 412 provides an abstraction layer that allows the OS to interface with certain hardware components that are utilized by IHS 400. Upon booting of IHS 400, host processor(s) 401 may utilize program instructions of BIOS 412 to initialize and test hardware components coupled to IHS 400, and to load a host OS for use by IHS 400. Via the hardware abstraction layer provided by BIOS/UEFI 412, software stored in system memory 406 and executed by host processor(s) 401 can interface with I/O devices coupled to IHS 400.

An Embedded Controller (EC) 413 (sometimes referred to as a Baseboard Management Controller or “BMC”) includes a microcontroller unit or processing core dedicated to handling selected IHS operations not ordinarily handled by host processor(s) 401. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 400, EC 413 may be made operational from the very start of each power reset, before other devices are fully running or powered on. As such, EC 413 may be responsible for interfacing with a power adapter to manage the power consumption of IHS 400. These operations may be utilized to determine the power status of IHS 400, such as whether IHS 400 is operating from battery power or is plugged into an AC power source. Firmware instructions utilized by EC 413 may be used to manage other core operations of IHS 400 (e.g., turbo modes, maximum operating clock frequencies of certain components, etc.).

In some cases, EC 413 may implement operations for detecting certain changes to the physical configuration or posture of IHS 400 and managing other devices in different configurations of IHS 400. For instance, when IHS 400 as a 2-in-1 laptop/tablet form factor, EC 413 may receive inputs from a lid position or hinge angle sensor 411, and it may use those inputs to determine: whether the two sides of IHS 400 have been latched together to a closed position or a tablet position, the magnitude of a hinge or lid angle, etc. In response to these changes, the EC may enable or disable certain features of IHS 400 (e.g., front or rear facing camera, etc.).

In some implementations, EC 413 may be installed as a Trusted Execution Environment (TEE) component to the motherboard of IHS 400. Additionally, or alternatively, EC 413 may be further configured to calculate hashes or signatures that uniquely identify individual components of IHS 400. In such scenarios, EC 413 may calculate a hash value based on the configuration of a hardware and/or software component coupled to IHS 400. For instance, EC 413 may calculate a hash value based on all firmware and other code or settings stored in an onboard memory of a hardware component.

In addition, EC 413 may provide an Out-of-Band communication channel that allows an Information Technology Decision Maker (ITDM) or Original Equipment Manufacturer (OEM) to manage IHS 400's various settings and configurations, for example, by issuing OOB commands.

In various embodiments, IHS 400 may be coupled to an external power source through an AC adapter, power brick, or the like. The AC adapter may be removably coupled to a battery charge controller to provide IHS 400 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 414 may be coupled to EC 413 and it may include, for example, an Analog Front End (AFE), storage (e.g., non-volatile memory), and a microcontroller. In some cases, BMU 414 may be configured to collect and store information, and to provide that information to other IHS components.

Examples of information collectible by BMU 414 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 400 may not include all the components shown in FIG. 4. Furthermore, some components that are represented as separate components in FIG. 4 may instead be integrated with other components, such that all or a portion of the operations executed by the illustrated components may instead be executed by the integrated component. For example, in various embodiments described herein, host processor(s) 401 and/or other components shown in FIG. 4 (e.g., chipset 402, display controller(s) 404, communication interface(s) 403, EC 413, etc.) may be replaced by other devices. As such, IHS 400 may assume different form factors including, but not limited to: servers, workstations, desktops, laptops, appliances, video game consoles, tablet computers, smartphones, etc.

In an example configuration, a system comprises an edge orchestrator configured to manage operation of edge devices, and a plurality of edge devices in communication with the edge orchestrator. Each of the edge devices comprises a processor, and a memory coupled to the processor. The memory has program instructions stored thereon that, upon execution, cause the processor to receive a data agent and a sharing agent from the edge orchestrator, collect data from an edge device location using the data agent, share portions of the collected data, by the sharing agent, with other edge devices using a secure multi-party computation protocol, aggregate a portion of the collected data with one or more shared portions of data collected by other edge devices, and send aggregated data to the edge orchestrator. The secure multi-party computation protocol may be selected from a Shamir secret sharing scheme, an additive secret sharing scheme, and a garbled circuit protocol.

The edge orchestrator may further comprise an edge orchestrator (EO) processor, and an EO memory coupled to the EO processor. The EO memory has program instructions stored thereon that, upon execution, cause the EO processor to aggregate multiple portions of aggregated data into computed data, wherein the portions of aggregated data are each received from a different edge device.

The system further comprises a secure channel established between each edge device and the edge orchestrator. The secure channel may use a Mutual Transport Layer Security (mTLS) protocol.

The system further comprises a secure cluster channel established between each edge device and the other edge devices. The edge device may use sharing agents to share the portions of the collected data with the other edge devices using the secure cluster channel.

In an example embodiment, a method for secure exchange of information comprises deploying data handling agents from an edge orchestrator to a cluster of edge devices, instructing the data handling agents to collect a defined set of data at each edge device, dividing the collected data into a plurality of shares by the data handling agents, transferring shares of the collected data among the edge devices so that a data set collected at each edge device is divided among all of the edge devices, computing-at each edge device-upon the shares of the collected data to create a computed data share, transferring the computed data shares from each edge device to the edge orchestrator; and aggregating-by the edge orchestrator-all of the computed data shares into a computed data set.

The data handling agents used in the method may comprise a data agent and a sharing agent.

The data agents on each edge device used in the method collect the defined set of data at an edge device location.

The method may further comprise transferring the collected data from the data agent to the sharing agent.

The sharing agent on each edge device used in the method creates a plurality of shares of the collected data.

The method may further comprise distributing the shares of collected data from each edge device to other edge devices so that each edge device has approximately the same size portion of the data share. The shares of collected data may be distributed among the edge devices using a secure channel for the edge device cluster. The shares of collected data are distributed using a secure multi-party computation protocol. The secure multi-party computation protocol may be a Shamir's secret sharing algorithm.

The data handling agents used in the method may be deployed using a deployment service on the edge orchestrator. The deployment service may define what data is to be collected and/or generated by the data handling agents on the ECE devices.

The computed data shares are aggregated into a computed data set using an aggregation engine on the edge orchestrator.

In a further embodiment, a system comprises a plurality of edge devices forming an edge cluster, an edge orchestrator having a deployment service and an aggregation engine, wherein the deployment service is configured to send data-collection instructions to a data agent on each of the edge devices, a secure orchestrator channel established between each edge device and the edge orchestrator, and a secure mesh channel established among the devices in the edge cluster, wherein the data agent on each edge device is configured to collect data from a respective location, and wherein a sharing agent is configured to distribute portions of the collected data among all of the devices in the edge cluster.

The sharing agent, on each edge device, may be further configured to compute a computed data share from distributed portions of edge device data and to transfer the computed data share to the aggregation engine; and wherein the aggregation engine is configured to aggregate computed data shares from each edge device into a computed data set.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A system, comprising:
an edge orchestrator configured to manage operation of edge devices; and
a plurality of edge devices in communication with the edge orchestrator, each of the edge devices comprising:
a processor; and
a memory coupled to the processor, the memory having program instructions stored thereon that, upon execution, cause the processor to:
receive a data agent and a sharing agent from the edge orchestrator;
collect data from an edge device location using the data agent;
share portions of the collected data, by the sharing agent, with other edge devices using a secure multi-party computation protocol;
aggregate a portion of the collected data with one or more shared portions of data collected by other edge devices; and
send aggregated data to the edge orchestrator.

2. The system of claim 1, wherein the edge orchestrator further comprises:
an EO processor; and
an EO memory coupled to the EO processor, the EO memory having program instructions stored thereon that, upon execution, cause the EO processor to:
aggregate multiple portions of aggregated data into computed data, wherein the portions of aggregated data are each received from a different edge device.

3. The system of claim 1, further comprising:
a secure channel established between each edge device and the edge orchestrator.

4. The system of claim 3, wherein the secure channel uses a Mutual Transport Layer Security (mTLS) protocol.

5. The system of claim 1, further comprising:
a secure cluster channel established between each edge device and the other edge devices.

6. The system of claim 5, wherein the edge device sharing agents share the portions of the collected data with the other edge devices using the secure cluster channel.

7. The system of claim 1, wherein the secure multi-party computation protocol is selected from a Shamir secret sharing scheme, an additive secret sharing scheme, and a garbled circuit protocol.

8. A method for secure exchange of information, comprising:
deploy data handling agents from an edge orchestrator to a cluster of edge devices;
instruct the data handling agents to collect a defined set of data at each edge device;
divide the collected data into a plurality of shares by the data handling agents;
transfer shares of the collected data among the edge devices so that a data set collected at each edge device is divided among all of the edge devices;
compute, at each edge device, upon the shares of the collected data to create a computed data share;
transfer the computed data shares from each edge device to the edge orchestrator; and
aggregate, by the edge orchestrator, all of the computed data shares into a computed data set.

9. The method of claim 8, wherein the data handling agents comprise a data agent and a sharing agent.

10. The method of claim 8, wherein the data agents on each edge device collect the defined set of data at an edge device location.

11. The method of claim 10, further comprising:
transfer the collected data from the data agent to the sharing agent.

12. The method of claim 8, wherein the sharing agent on each edge device creates a plurality of shares of the collected data.

13. The method of claim 12, further comprising:
distribute the shares of collected data from each edge device to other edge devices so that each edge device has approximately the same size portion of the data share.

14. The method of claim 13, wherein the shares of collected data are distributed among the edge devices using a secure channel for the edge device cluster.

15. The method of claim 13, wherein the shares of collected data are distributed using a secure multi-party computation protocol.

16. The method of claim 15, wherein the secure multi-party computation protocol is a Shamir's secret sharing algorithm.

17. The method of claim 8, wherein the data handling agents are deployed using a deployment service on the edge orchestrator.

18. The method of claim 8, wherein the computed data shares are aggregated into a computed data set using an aggregation engine on the edge orchestrator.

19. A system comprising:
a plurality of edge devices forming an edge cluster;
an edge orchestrator having a deployment service and an aggregation engine, the deployment service configured to send data-collection instructions to a data agent on each of the edge devices;
a secure orchestrator channel established between each edge device and the edge orchestrator; and
a secure mesh channel established among the devices in the edge cluster;
wherein the data agent on each edge device is configured to collect data from a respective location, and wherein a sharing agent is configured to distribute portions of the collected data among all of the devices in the edge cluster.

20. The system of claim 19, wherein the sharing agent, on each edge device, is further configured to compute a computed data share from distributed portions of edge device data and to transfer the computed data share to the aggregation engine; and wherein the aggregation engine is configured to aggregate computed data shares from each edge device into a computed data set.
